(19) United States
(12) Patent Application Publication
(10) Pub. No.: US 2020/0406676 A1
(43) Pub. Date: Dec. 31, 2020

(54) WHEEL POSITIONING SURFACE CORRECTION DEVICE

(71) Applicant: CITIC Dicastal CO., LTD., Qinhuangdao (CN)

(72) Inventors: Weimin CAI, Qinhuangdao (CN); Jiandong GUO, Qinhuangdao (CN); Minghua LIU, Qinhuangdao (CN)

(21) Appl. No.: 16/700,169

(22) Filed: Dec. 2, 2019

(30) Foreign Application Priority Data
Jun. 27, 2019 (CN) 201910565520X

(51) Int. Cl. B60B 29/00; B60B 7/00; B60B 7/06; B60B 31/04; B60B 31/06

(52) U.S. Cl. CPC B60B 29/001; B60B 7/0066; B60B 7/063; B60B 2310/228; B60B 31/04; B60B 31/06; B60B 2320/14; B60B 7/065

(57) ABSTRACT

Disclosed in the present disclosure is a wheel locating surface correction device, comprising a frame, a correction ring and a correction plate. The correction plate is provided above a wheel blank. The structure can correct the roundness of the radial positioning surface of the blank, and the flatness of the axial positioning surface of the blank before machining to improve the roundness of the blank rim, improving the wheel yield and the processing quality.

### CROSS-REFERENCE TO RELATED APPLICATION

This application claims the priority to Chinese Patent Application No. 201910565520X, entitled “Wheel Positioning Surface Correction Device”, filed Jun. 27, 2019, the entire content of which is hereby incorporated by reference.

### TECHNICAL FIELD

The present disclosure relates to a wheel, and in particular relates to a wheel positioning surface correction device.

### BACKGROUND

A machined blank of a wheel is obtained by casting, heat treatment, and other processes. The actual positioning surface of the machined blank may be deformed, the radial positioning surface may be radially deformed and the axial positioning surface may be axially deformed. In machining the existing blank, there is a certain position deviation and angle deviation between the center axis of the machined blank of the wheel and the theoretical axis, so that there are a certain amount of the waste products relating to balance or machining deviations after the wheel is machined, affecting the yield and quality of the products.

### SUMMARY

In view of this, the aim of the present disclosure is to provide a wheel positioning surface correction device, the device corrects the roundness of the radial positioning surface of the blank, and the flatness of the axial positioning surface before machining, so as to improve the roundness of the blank rim. So that the wheel yield and the processing quality can be improved, and simultaneously, the processing amount of the blank and the manufacturing cost of the wheel can be further reduced.

In order to achieve the above object, the technical solutions of the present disclosure are achieved as follows:

A wheel positioning surface correction device comprises a frame, a bottom plate is fixed on the frame, side plates are fixed on both sides of the bottom plate, a top plate is overlapped at the top of the side plate, a positioning plate is fixed on the bottom plate, a positioning seat is fixed in the center of the positioning plate, a positioning mandrel is fixed on the top of the positioning seat, and the device further comprises: a correction ring, one side of the correction ring being connected to a piston rod of a cylinder I fixed to the side plate, another side of the correction ring being configured as a concave semicircular correction surface with the same radius as the outer cylinder of a wheel lip of a wheel blank, and a correction plate, the correction plate being provided above the wheel blank, and the bottom surface of the correction plate corresponding to the axial positioning surface of the wheel lip of the wheel blank being provided with a convex annular correction surface, and the center of the top surface of the correction plate being connected to a piston rod of a cylinder II fixed to the top plate.

In one embodiment, the correction ring are symmetrically provided on both sides of the outer cylinder of the wheel lip of the wheel blank, so that it can cover the radial positioning surface of the wheel lip under the action of the cylinder I and the roundness of the radial positioning surface of the wheel lip can be corrected.

In one embodiment, a clamping device is also provided on the bottom plate and around the lower rim of the wheel blank, and the clamping device can press the wheel blank.

In one embodiment, the clamping device comprises a pressing claw, one end of the pressing claw is fixed to the bottom plate by a blot, and the other end of the pressing claw is pressed against the lower rim of the wheel blank.

In one embodiment, a support base is fixed on the bottom plate, a guide rail is provided on the support base, and the bottom surface of the correction ring is provided on the guide rail.

In one embodiment, the semicircular correction surface and the annular correction surface have a roughness Ra≤0.8 mm.

Compared with the prior art, the wheel positioning surface correction device of the present disclosure has the following advantages:

The disclosure has a simple structure and reliable performance. The roundness of the radial positioning surface of the blank and the flatness of the axial positioning surface can be corrected before machining to improve the roundness of the blank rim, and the wheel yield and the processing quality can be improved.

### BRIEF DESCRIPTION OF THE DRAWINGS

The drawings forming a part of the disclosure are used to provide a further understanding of the disclosure, and the illustrative embodiments of the present disclosure and the description thereof are intended to explain the present disclosure and are not intended to limit the disclosure. In the drawings:

FIG. 1 illustrates a front view of the wheel positioning surface correction device according to some embodiment of the present disclosure;

FIG. 2 illustrates a top view of the wheel positioning surface correction device according to some embodiment of the present disclosure;

FIG. 3 illustrates a side view of the wheel positioning surface correction device according to some embodiment of the present disclosure;

FIG. 4 is a partial enlarged schematic diagram of the correction process of the wheel positioning surface correction device according to some embodiment of the present disclosure;

FIG. 5 is a comparison diagram of the wheel positioning surface correction device of the disclosure before and after the axial positioning surface correction according to some embodiment of the present disclosure; and

FIG. 6 is a comparison diagram of the wheel positioning surface correction device of the disclosure before and after the radial positioning surface correction according to some embodiment of the present disclosure.

Reference numerals: 1. frame, 2. support, 3. guide rail, 4. cylinder I, 5. correction ring, 6. correction plate, 7. wheel blank, 70. wheel lip, 71. radial positioning surface, 72. axial positioning surface, 8. cylinder II, 9. top plate, 10. positioning plate, 11. pressing claw, 12. positioning seat, 13. positioning mandrel, 14. bottom plate, 15. side plate.

### DETAILED DESCRIPTION

The accompanying drawings forming a part of the present disclosure are used to provide a further understanding of the present disclosure, and the schematic embodiments and the descriptions of the present disclosure serve to explain the present disclosure and do not constitute an improper limitation of the present disclosure. In the drawings:

The technical solutions of the present disclosure will be described clearly and completely hereinafter with reference to the accompanying drawings in conjunction with the embodiments. Obviously, the described embodiments are only a part of the embodiments of the disclosure and not all of them. Based on the embodiments in the disclosure, all other embodiments obtained by those skilled in the art without creative efforts are within the scope of protection of the disclosure.

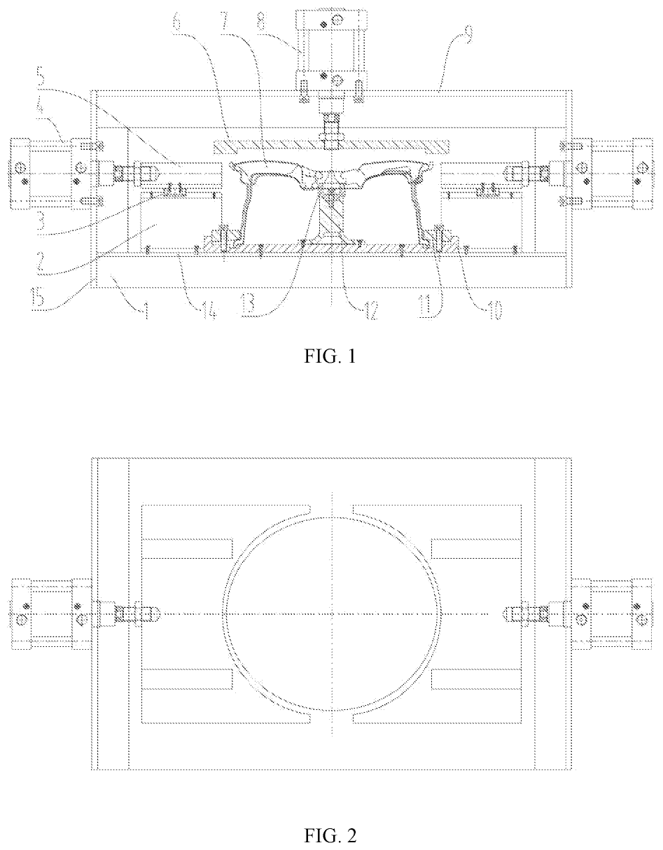

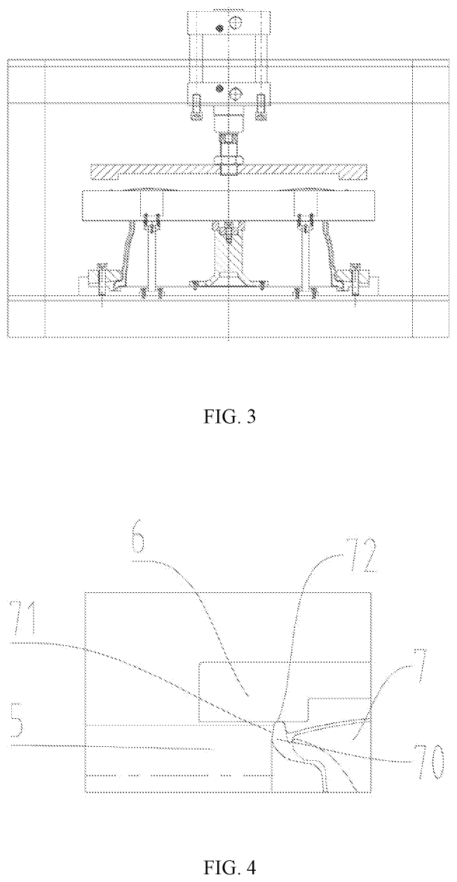

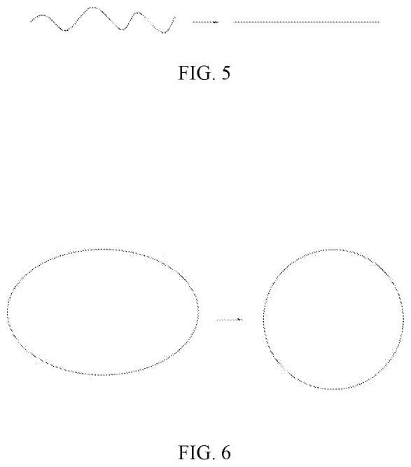

The wheel positioning surface correction device of the embodiment of the present disclosure will be described below with reference to FIGS. 1-6 in combination with the embodiment.

The technical terms or the explanation of the technical terms are used in this embodiment.

Radial positioning surface of the wheel: the outer cylinder surface of the wheel lip blank is used for radial positioning of the wheel before the wheel is machined, and the surface is referred to as the radial positioning surface.

Axial positioning surface of the wheel: the torus of the wheel lip blank is used for axial positioning of the wheel before the wheel is machined, and the surface is referred to as the axial positioning surface.

As shown in FIGS. 1-6, the wheel positioning surface correction device includes: a frame 1, a bottom plate 14 is fixed on the frame 1, side plates 15 are fixed on both sides of the bottom plate 14, and a top plate 9 is overlapped at the top of the side plate 15, wherein, a positioning plate 10 is fixed on the bottom plate 14, a positioning seat 12 is fixed in the center of the positioning plate 10, a positioning mandrel 13 is fixed on the top of the positioning seat 12, and the device further includes: a correction ring 5, one side of the correction ring 5 being connected to a piston rod of a cylinder I 4 fixed to the side plate 15, another side of the correction ring 5 being configured as a concave semicircular correction surface with the same radius as the outer cylinder of a wheel lip 70 of a wheel blank 7; and a correction plate 6, the correction plate 6 being provided above the wheel blank 7, and the bottom surface of the correction plate 6, corresponding to the axial positioning surface 72 of the wheel lip 70 of the wheel blank 7, being provided with a convex annular correction surface, and the center of the top surface of the correction plate 6 being connected to a piston rod of a cylinder II 8 fixed to the top plate 9.

In one embodiment, the correction ring 5 are symmetrically provided on both sides of the outer cylinder of the wheel lip 70 of the wheel blank 7, so that it can cover the radial positioning surface 71 of the wheel lip 70 under the action of the cylinder I 4 and the roundness of the radial positioning surface 71 of the wheel lip 70 can be corrected.

In one embodiment, a clamping device is also provided on the bottom plate 14 and around the lower rim of the wheel blank 7, and the clamping device can press the wheel blank 7.

In one embodiment, the clamping device includes a pressing claw 11, one end of the pressing claw 11 is fixed to the bottom plate 14 by a blot, and the other end of the pressing claw 11 is pressed against the lower rim of the wheel blank 7.

The clamping device can be other devices that can clamp the wheel blank 7.

In one embodiment, a support 2 is fixed on the bottom plate 14, a guide rail 3 is provided on the support 2, the bottom surface of the correction ring 5 is provided on the guide rail 3, and the cylinder I 4 drives the correction ring 5 to move on the guide rail 3 by the piston rod.

In one embodiment, the semicircular correction surface and the annular correction surface have a roughness Ra≤0.8 mm.

In actual use, the wheel blank 7 is placed in a heating furnace, heated to 350° C. and kept for 10 minutes to improve the plasticity of the wheel, reduce the elastic modulus, and facilitate deformation and finishing. The heated wheel blank 7 is placed on the positioning mandrel 13 and the positioning plate 10, positioned and clamped, the cylinder II 8 is driven to move the correction plate 6 downward, pressing against the axial positioning surface 72 of the wheel blank 7 and correcting the flatness of the axial positioning surface 72. The cylinder I 4 is driven to move the correction ring 5 to the middle, pressing the radial positioning surface 71 of the wheel blank 7 and correcting the roundness of the radial positioning surface 71.

Compared with the prior art, the wheel positioning surface correction device of the present disclosure has the following advantages:

The disclosure has a simple structure and reliable performance. The roundness of the radial positioning surface of the blank and the flatness of the axial positioning surface can be corrected before machining to improve the roundness of the blank rim, and the wheel yield and the processing quality can be improved.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A wheel positioning surface correction device, comprising:
a frame,
a bottom plate being fixed on the frame,
side plates being fixed on both sides of the bottom plate, and
a top plate being overlapped at the top of the side plate,
wherein: a positioning plate is fixed on the bottom plate, a positioning seat is fixed in the center of the positioning plate, a positioning mandrel is fixed on the top of the positioning seat, and the device further comprises:
a correction ring, one side of the correction ring being fixedly connected to a piston rod of a cylinder I fixed to the side plate, another side of the correction ring being configured as a concave semicircular correction surface with the same radius as the outer cylinder of a wheel lip of a wheel blank; and
a correction plate, the correction plate being provided above the wheel blank, and the bottom surface of the correction plate corresponding to the axial positioning surface of the wheel lip of the wheel blank being provided with a convex annular correction surface, and the center of the top surface of the correction plate being connected to a piston rod of a cylinder II fixed to the top plate.

2. The wheel positioning surface correction device according to claim 1, wherein: the correction rings are symmetrically provided on both sides of the outer cylinder of the wheel lip, and can cover the radial positioning surface of the wheel lip under the action of the cylinder I and the roundness of the radial positioning surface of the wheel lip can be corrected.

3. The wheel positioning surface correction device according to claim 2, wherein: a clamping device is also provided on the bottom plate and around the lower rim of the wheel blank, and the clamping device can press the wheel blank.

4. The wheel positioning surface correction device according to claim 3, wherein the clamping device comprises:
a pressing claw,
one end of the pressing claw is fixed to the bottom plate by a blot, and the other end of the pressing claw is pressed against the lower rim of the wheel blank.

5. The wheel positioning surface correction device according to claim 3, wherein: a support is fixed on the bottom plate, a guide rail is provided on the support, and the bottom surface of the correction ring is provided on the guide rail.

6. The wheel positioning surface correction device according to claim 2, wherein the semicircular correction surface and the annular correction surface have a roughness Ra≤0.8 mm.
